(19) United States
(12) Patent Application Publication
(10) Pub. No.: US 2026/0296151 A1
(43) Pub. Date: Oct. 1, 2026

(54) MOTOR VEHICLE WITH HEIGHT DETERMINATION FOR AUTOMATICALLY OPENING TAILGATE

(71) Applicant: Honda Motor Co., Ltd., Tokyo (JP)

(72) Inventors: Andrew R. HOOVER, West Liberty, OH (US); Steven Feit, Dublin, OH (US); Leah P. Hutchinson, Dublin, OH (US)

(21) Appl. No.: 19/090,810

(22) Filed: Mar. 26, 2025

(51) Int. Cl. B60J 5/10; E05F 15/73; E05F 15/77

(52) U.S. Cl. CPC B60J 5/101; E05F 15/73; E05F 15/77; E05F 2015/765; E05Y 2400/354; E05Y 2900/546

(57) ABSTRACT

A vehicle with a tailgate includes a system for opening the tailgate when an authorized user of the vehicle approaches the vehicle. The system may include a sensor mounted to the vehicle that may be used to communicate with a user to detect for a height of the user. The system may then be used to control an opening of the tailgate based on the user height. The system may be used to open the tailgate to a height slightly greater than a height of the user. The system may also be used to start opening the tailgate based on the approach speed of the user so that the tailgate finished opening as the user arrives at the tailgate. The system may use an ultra-wide band wireless communication between the user and the vehicle tailgate control systems.

### TECHNICAL FIELD

The present disclosure generally relates to a land motor vehicle, and more particularly, to systems and methods for automatically detecting a presence and height of an authorized person approaching a motor vehicle and automatically opening the tailgate to a height appropriate for the person.

### BACKGROUND

A land vehicle or motor vehicle such as a sport utility vehicle (SUV) or van may include a tailgate on a rear end of the vehicle. Such vehicle can also be referred to as a hatchback. A tailgate on an SUV may occupy most of the rear side of the vehicle. As such, when the tailgate is open, most of the rear side of the vehicle is open to the inside. Often, a person may be at a shopping store such as a grocery store. The person or user of the vehicle with a tailgate may approach the vehicle with arms full of bags or items. With arms full, the user may not be able to easily or conveniently access a device such as a vehicle FOB or a handle or button on the tailgate to cause the tailgate to open. The user is therefore possibly left struggling to put down their groceries, and then pick them back up again after opening the tailgate in order to place the bags or items into the vehicle.

Additionally, in some vehicles having tailgates, the tailgate may open too slow. The user would then be holding items while waiting for the tailgate to open enough to place some or all of the items into the vehicle. Furthermore, in some vehicles having tailgates, the tailgate may open to a height where the user could bump their head on the bottom of the tailgate, or the tailgate may open to a height that is too high when in a confined space such as a parking garage having a low ceiling or too high for the user to easily reach to initiate closing of the tailgate.

### SUMMARY

The present disclosure is directed to a motor vehicle, the motor vehicle comprising: a tailgate hinged to a upper side of a rear portion of the vehicle; an actuator to open the tailgate; a control system to regulate the actuator to open and close the tailgate; a user detection system to sense a person approaching the vehicle; the user detection system detecting a height of the approaching person using ultra-wide band signals; and the user detection system communicating with the control system to open the tailgate at a level that is above the height of the approaching person but less than fully open.

In other embodiments, the present disclosure is directed to a motor vehicle, the motor vehicle comprising: a tailgate hinged to a upper side of a rear portion of the vehicle; an actuator to open the tailgate; a control system to regulate the actuator to open and close the tailgate; a user detection system to sense a person approaching the vehicle; the user detection system including an ultra-wide band signal device and a video camera, the user detection system being configured to detect a height of the approaching person using ultra-wide band signals from the ultra-wide band signal device in combination video data captured by the video camera; and the user detection system communicating with the control system to open the tailgate at a level that is above the height of the approaching person.

In a third respect, this present disclosure is directed to a method for automatically opening a tailgate of a motor vehicle comprising the steps of: detecting a person approaching the motor vehicle; detecting a height of the person approaching the vehicle using ultra-wide band signals; determining if the person approaching the motor vehicle is an authorized user to operate the land vehicle using the ultra-wide band signals; opening the tailgate to a level that is above the height of the approaching person but less than fully open.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 shows a perspective view of an exemplary motor vehicle with an open tailgate, according to an embodiment;

FIG. 2 shows a side view of the motor vehicle shown in FIG. 1 with a person carrying a full load in both arms approaching a rear of the vehicle, according to an embodiment;

FIG. 3 shows a side view of the motor vehicle shown in FIG. 1 and FIG. 2 with the person associated with a device in wireless communication with the vehicle, according to an embodiment;

FIG. 4 shows a side view of the motor vehicle shown in FIG. 1, FIG. 2, and FIG. 3 with the tailgate starting to open, according to an embodiment;

FIG. 5 shows a side view of the motor vehicle shown in FIG. 1, FIG. 2, FIG. 3, and FIG. 4 with the person positioned close to an opened tailgate with a tailgate height just above a head of the user, according to an embodiment;

FIG. 6 shows a top view of the motor vehicle shown in FIG. 1, FIG. 2, FIG. 3, FIG. 4, and FIG. 5 with the person walking to a driver side of the vehicle and the tailgate moving back to a closed position, according to an embodiment;

FIG. 7 shows a top view of an exemplary motor vehicle with two users approaching a rear of the vehicle at different speeds, according to an embodiment;

FIG. 8 shows a flow chart of a method of activating a control system for a tailgate of a vehicle, according to an embodiment.

### DESCRIPTION OF THE EMBODIMENTS

According to the principles of the example embodiments described herein, disclosed are methods and systems for a motor vehicle with an automatic control system for opening a tailgate of the vehicle as an authorized person approaches the rear side of the vehicle where the tailgate is located. In some embodiments, an automatic control system may use an ultrawide band (UWB) system of wireless communication in order to simultaneously achieve: location of an approaching user, determination of the user's height, and authentication of the user via data exchange with a device associated with the user. That is, in some aspects, the UWB system may be used to determine a height of the user. In other aspects, the UWB system may be used to detect an approaching speed of a user. Knowing an approaching user's height and speed may allow the system to open the tailgate to just above the user head, and to start opening the tailgate so that the tailgate may be opened just as the user arrives at the opened tailgate. The system allows for wireless communication with a user that may have both hands and arms full and thus cannot retrieve a device to open the tailgate by hand. This aspect allows the user to place carried items into the rear of the vehicle without having to wait for the tailgate to finish opening.

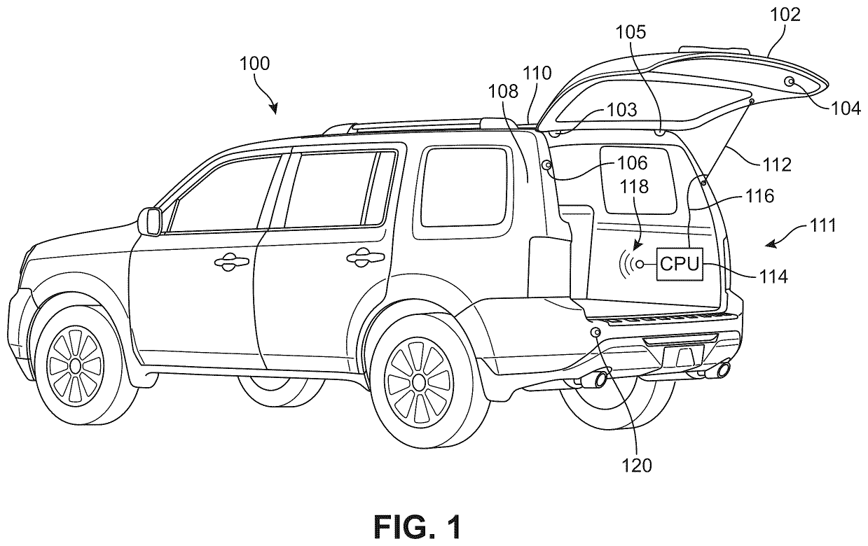

Referring to FIG. 1, an example embodiment of a motor vehicle 100 with a tailgate 102 on a rear side 108 of the vehicle 100 is shown. Motor vehicle 100 may have one or more cameras. One or more cameras may be multiple view cameras, or rear view cameras, or a combination of different types of cameras in different locations on the motor vehicle 100. In some aspects, a first camera 104 may be mounted to tailgate 102. In other aspects, a second camera 106 may be mounted to a side of the rear 108 of the vehicle 100. In some aspects, the vehicle may have more than one camera on the tailgate and on the side of the rear of the vehicle.

In some embodiments, land vehicle 100 may include a tailgate 102 rotatably coupled to an upper side 110 of a rear portion 108 of the vehicle, for example, by hinge 103, 105. In the exemplary embodiment, vehicle 100 includes a tailgate opening system 111. In the exemplary embodiment, the tailgate opening system 11 includes an actuator 112 and a tailgate controller 114. In some aspects, an actuator 112 may be used to open the tailgate 102. Actuator 112 may be a linear actuator. A linear actuator may be a pneumatic actuator, a hydraulic actuator, a spring loaded actuator, an electric actuator, or any other known actuator. Actuator 112 may be controlled by a tailgate controller 114. Tailgate controller 114 may include a processor such as a central processing unit (CPU) or any other device that allows the system to function as described herein. The processor may be located within the vehicle. Controller 114 may be in wireless communication with a device carried by a user of the vehicle. A device caried by a user of the vehicle may be used to open or close the tailgate. As an example embodiment, actuator 112 may be an electric actuator and an electrical wire 116 may be used to connect the controller 114 to the actuator 112.

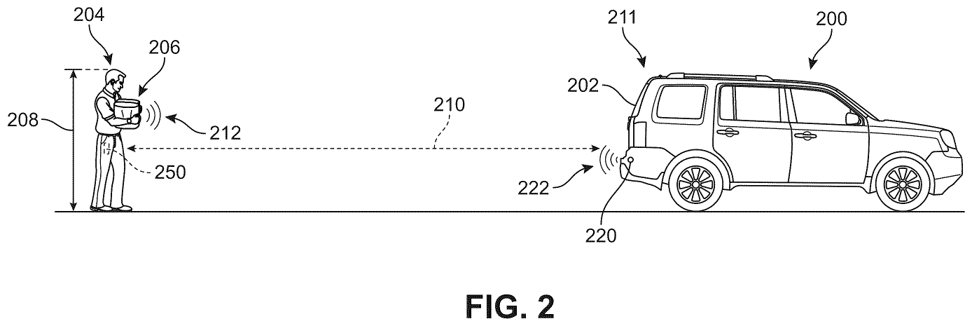

FIG. 2 shows an embodiment of a motor vehicle 200 with a tailgate 202. In some aspects, a user 204 of a vehicle may be a person authorized to unlock the vehicle to gain access. User 204 may have height 208. A user 204 of the vehicle 200 may have an arm or both arms full of one or more packages. Generally, having arms full of a package or more may indicate that the user does not have a free hand to either open the tailgate themselves or to activate a device to open the tailgate. For example, user 204 may not be able to reach for a tailgate opening device on the vehicle 200 that when depressed or pulled will open the tailgate. In other cases, user 204 may not have a free hand to reach within a pocket to retrieve a vehicle fob to press a button to open the tailgate.

Instead, as shown in FIG. 2, user 204 may be a first distance 210 away from vehicle 200 which allows wireless electronic communication between vehicle ultra-wide band device 220 and a device 250 associated with user 204. Namely, ultra-wide band device 220 may emit ultra-wide band signal 222 that allows for wireless communication with device 250 over a local wireless protocol. Device 250 may be a mobile computing device, such as a smart phone, or may be a key fob device that is specifically configured to accompany vehicle 200.

In the exemplary embodiment, system 211 on vehicle 200 detects the presence of user 204 based at least in part on detection of a device associated with user 204. For example, user 204 may have a device 250 on their person able to transmit wireless signals 212. Furthermore, system 211 includes a transceiver 220 included in or on vehicle 200 that is able to receive wireless signals 212 and transmit wireless signals 222. For example, wireless signal 222 may be emitted by device 220 on vehicle 200, and received by device 250 associated with user 204. Then, device 250 may similarly in turn emit signal 212 that may be received by device 220 on vehicle 200.

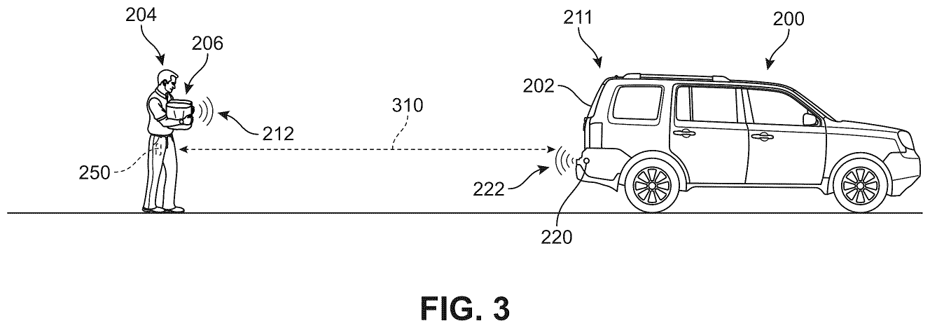

Then, FIG. 3 shows user 204 approaching a rear of the motor vehicle 200 with tailgate 202 at second distance 310. User 204 may be carrying a package 206. Package 206 may be large enough that user does not have a free hand to use a device that may be used to open the tailgate 202. In some embodiments, vehicle 200 may include system 211 to detect a presence of an authorized user as the user approaches the vehicle. In some embodiments, the system 211 may be able to detect one or more characteristics of an approaching user. In some aspects, a characteristic of a user may be a height of the user. In other aspects, a characteristic of a user may be an approach speed of the user to the vehicle. In other aspects, a characteristic of a user may be a gait analysis of the user.

In an exemplary embodiment, tailgate opening system 211 improves operation of the tailgate 202. As described above, system 211 may include device 220 used to detect the presence of user device 250. In addition, or alternatively, device 220 may include a vision sensor, or an ultrawide band sensor, or a combination of these sensors. In particular embodiments, the system 211 may include both a ultra-wide band device and a video camera in order to detect and identify one or more characteristics of the approaching user 204. The combination of both a ultra-wide band device and a video camera may allow more precise detection of a user's height, and may also allow improved detection of a user height under variety of conditions such as low light, rain, or other weather conditions.

Specifically, an ultra-wide band (UWB) device may be used to detect a shape of an object such as user 204 by emitting and receiving back ultra-wide band signals in a form of radar imaging. Ultra-wideband is a known radio technology that allows the vehicle 200 to determine characteristics of the approaching user 204 based on ultra-wide band signals emitted by system 211, reflected off of user 204 and received back at system 211.

Ultra-wideband was formerly also known as pulse radio, but the FCC and the International Telecommunication Union Radiocommunication Sector (ITU-R) currently define UWB as an antenna transmission for which emitted signal bandwidth exceeds the lesser of 500 MHz or 20% of the arithmetic center frequency. Thus, pulse-based systems-where each transmitted pulse occupies the UWB bandwidth (or an aggregate of at least 500 MHz of a narrow-band carrier; for example, orthogonal frequency-division multiplexing (OFDM))-can access the UWB spectrum under the rules.

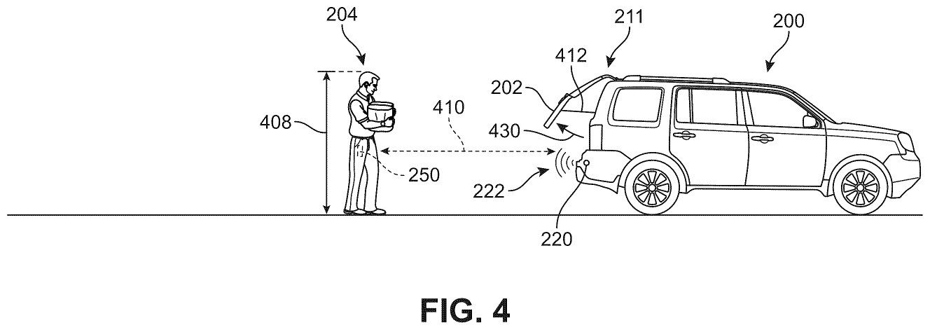

FIG. 4 shows an example embodiment in which tailgate 202 of vehicle 200 is starting to open 430. Namely, a user detection system 211 that includes ultra-wide band device 220 may engage in wireless electronic communication with device 250 associated with user 204 via ultra-wide band signals 222 in order to confirm that user 204 is an authorized user for which the tailgate should open. That is, user detection system 211 in vehicle 200 is configured to engage in wireless electronic communication with a mobile computing device or key fob device 250 associated with the approaching person 204 using ultra-wide band signals 222, and determine that the approaching person 204 is an authorized person based on data received from the mobile computing device or key fob 250 before opening the tailgate. User detection system 211 may do this when user 204 comes closer to vehicle 200, such as at distance 410.

In this way, the ultra-wide band signals 222 may be used for both radar imaging to determine the height 408 (and location) of user 204, and also for data transmission to and from personal device 250. Signal device 220 may therefore be configured to achieve all of these purposes, by both emitting and receiving ultra-wide band signals- and engaging in appropriate signal processing in conjunction with a controller, and a processor therein.

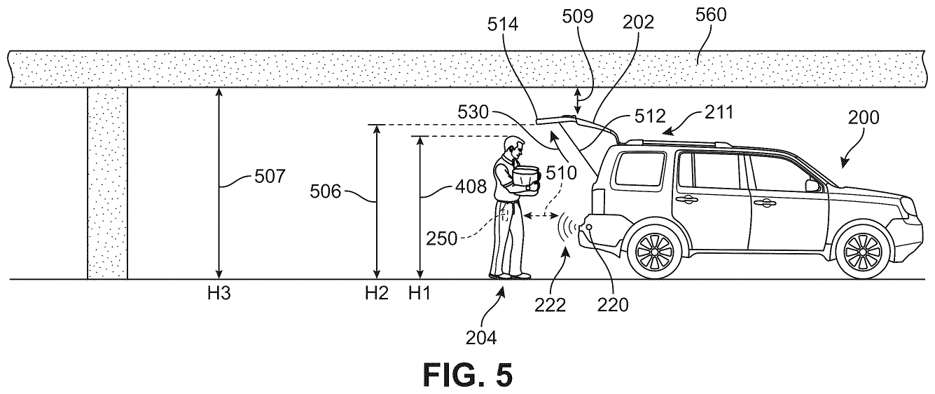

Next, FIG. 5 shows vehicle 200 with an open tailgate 202. In some aspects, the system may detect a height 408 (H1) of user 204 approaching the vehicle 200 using ultra-wide band signals as discussed above. In some aspects, the system may open the tailgate to a height 506 (H2) that may be slightly higher than 408 (H1). This may be used to prevent user from hitting their head on the open tailgate as the user may be inserting a package into the rear of vehicle 400. Height 506 may also put tailgate 202 to be less than fully open. This may allow tailgate 202 to open an amount necessary for user 204, but prevent tailgate 202 from hitting low ceiling 560 such as when vehicle 200 is e.g. in a parking garage. In this way, a control system that receives data from a user detection system 211 may cause tailgate 202 to open to height 506 that is distance 509 below ceiling 560 height 507 in order to avoid scratches or other damage to tailgate 202.

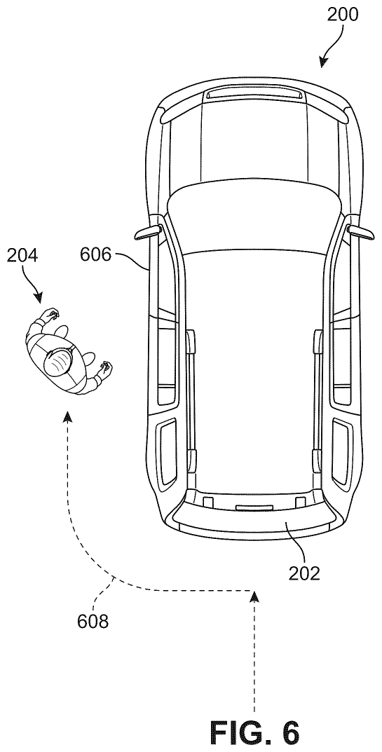

After a person has put their packages into the vehicle upon the tailgate being sufficiently opened as shown in FIG. 6, the user may then walk away from the tailgate as shown in FIG. 6. Namely, FIG. 6 shows an example embodiment in which the person using the vehicle may open the tailgate, place a carried object within the open tailgate of the vehicle, close the tailgate, and then walk toward a driver side door of the vehicle. Vehicle 200 may have a tailgate 202 that automatically senses that user 204 has moved away from tailgate 202 and closes tailgate 202 in response. In this way, person 204 may follow a path 608 from a tailgate 202 around a side of the vehicle and toward a driver side door 606 without needing to manually close tailgate 202 or push any button to do so. Person 204 may then conveniently enter the vehicle with the tailgate closed and drive away.

Namely, the system for controlling the tailgate of a land vehicle may be used to detect when a person has moved away from the rear of the vehicle after the tailgate has been opened. As an example, the system may be used to open the tailgate as the person approaches the tailgate. The person may then deposit an item carried by the user into the cargo space within the vehicle. The user may then walk away from the tailgate. For example, the user may walk toward the driver side door in order to enter the vehicle to drive away. The system may be used to detect that the user has moved away from the rear of the vehicle and then start to close the tailgate. This step may be performed automatically without input from the user.

In a particular embodiment in accordance with FIG. 6, the system for controlling the tailgate of a land vehicle may monitor the user's movement away from the tailgate and pause the tailgate closing and instead open the tailgate again if the user moves back towards the tailgate. Namely, the system may pause the closing of the tailgate and reopen the tailgate when the user moves away from—and then back towards—the tailgate. This may occur when, for example, the user is in the middle of loading several items into the trunk and moves away from the tailgate to grab another item but then moves back towards the tailgate to load that item. In this way, the process of automatically closing the tailgate described directly above and shown in FIG. 6 may be paused, reversed, and then restarted.

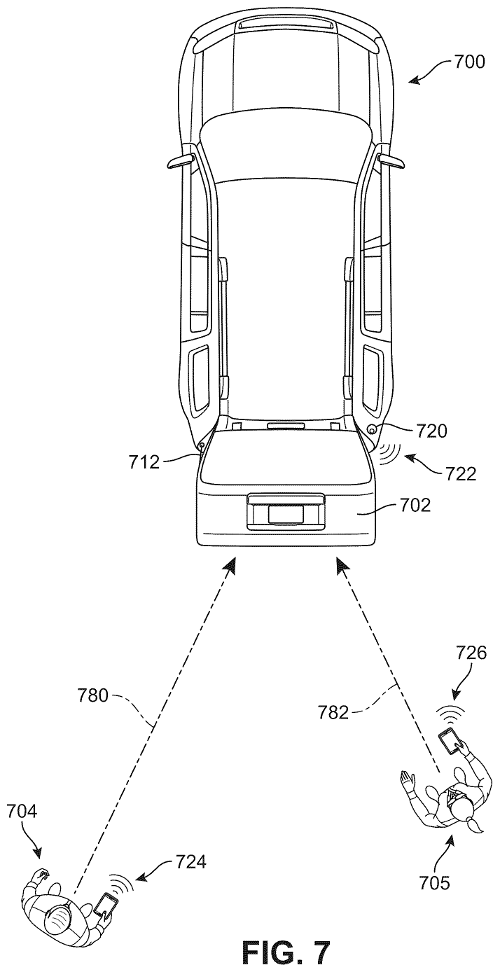

In some aspects, the system for controlling the tailgate of the vehicle may be used to detect an approach vector, including speed, of an approaching authorized user of the vehicle. FIG. 7 shows two people having different approach speeds approaching the tailgate 702. In an example embodiment, a first person 704 may approach the tailgate at a first speed 780 that is greater than a second speed 782 by which a second user 705 is approaching the vehicle 700. In some embodiments, the tailgate control system 111 determines which user is authorized to access the interior of vehicle 700 based on communication with devices 724 and 726. The system 111 detects a speed 780, 782 of the authorized user of the vehicle and that user's current position—in order to start opening the tailgate 702 at an appropriate time so that the tailgate 702 will be fully opened (to a desired height) just as the authorized user is close to the opened tailgate. As a result, a user may not need to wait for the tailgate to open while carrying packages. A user may then place the items being carried directly into the open vehicle without the need to wait or manually operate any control to open the tailgate.

Additionally, ultra-wide band signal 722 may also be used to identify a gait of an authorized user. Gait analysis is a well known way of identifying specific people. In embodiments, a user detection system of vehicle 700 may use ultra-wide band signals 722 to identify a gait of user 704 or user 705 in order to determine whether a user is an authorized user. When a gait analysis of a user 704, 705 matches or otherwise corresponds to a stored preprogrammed gait analysis of an authorized user, the user detection system may signal the control system to open the tailgate 702. In this way, gait analysis may be useful as another way of authenticating whether the tailgate 702 should be opened in response to an approaching person, in addition to authentication via a device such as mobile computing device 724 or mobile computing device 726.

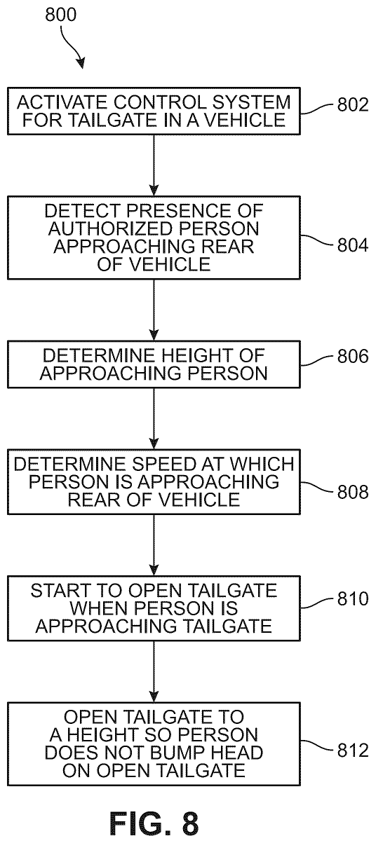

Finally, FIG. 8 shows a flowchart of an embodiment of a method 800 with an active control system for a tailgate in a vehicle. First, step 802 may include activating the system. Activating the system may include detecting an approach of an authorized user toward a vehicle with a tailgate. Next, step 804 may include detecting an approach of a user from a rear end of the vehicle toward the tailgate such as a predetermined distance as shown in FIG. 3 discussed above. Step 804 may include the use of UWB wireless signals to detect the presence of the person, and also the use of UWB signals to engage in wireless communication between a device associated with the user and vehicle tailgate control system.

Step 806 may include detecting a height of an approaching user of the vehicle, using ultra-wide band signals as variously discussed above. Then, step 808 may include determining a speed at which a user is approaching the vehicle, in order to time the opening of the tailgate to match when the user will arrive at the tailgate so as to prevent the user from having to wait for the tailgate to open. In some aspects, step 808 may be used to detect a user approaching the vehicle from the rear end toward the tailgate.

Step 810 may be used in the system to start to open the tailgate when a user is approaching the tailgate, such as when the user has reached a predetermined distance away from the vehicle as shown in FIG. 4 discussed above. Step 810 may include using a height of the user as determined in step 806 to determine when and how much the tailgate opens. In some aspects, knowing a height of the user of the vehicle may allow for the system to control the tailgate to open to a height slightly above the height of the user. Finally, step 812 may be used in the system to open the tailgate to a minimum height as required to be slightly greater than a detected height of the user as shown in FIG. 5 discussed above. Accordingly, this may prevent the user from bumping their head up against the opened tailgate.

In some embodiments, step 810 may be used to start to open the tailgate based on a speed of approach of a user of the vehicle. In some aspects, the system may be used to start to open the tailgate in order to have the tailgate opened at the minimal height as the user is close to the open tailgate. This may allow for the system to open the tailgate without the user needing to wait for the tailgate to finish opening. In a raining environments, for example, this aspect may be used to minimize the user getting wet as much.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A motor vehicle, the motor vehicle comprising:
a tailgate hinged to a upper side of a rear portion of the vehicle;
an actuator to open the tailgate;
a control system to regulate the actuator to open and close the tailgate;
a user detection system to detect a person approaching the vehicle;
the user detection system detecting a height of the approaching person using ultra-wide band signals; and
the user detection system communicating with the control system to open the tailgate at a level that is above the height of the approaching person but less than fully open.

2. The motor vehicle of claim 1, wherein
the user detection system is configured to engage in wireless electronic communication with a mobile computing device associated with the approaching person using ultra-wide band signals, and determine that the approaching person is an authorized person based on data received from the mobile computing device before opening the tailgate.

3. The motor vehicle of claim 2, wherein
the user detection system electronically communicates with the control system such that the control system opens the tailgate just in time as the user approaches the rear portion of the vehicle.

4. The motor vehicle of claim 1, wherein the actuator is a linear actuator.

5. The motor vehicle of claim 1, wherein the user detection system further includes a video camera.

6. The motor vehicle of claim 1, wherein the user detector system is configured to engage in wireless electronic communication with a key fob device carried by the approaching person and determine if the approaching person is an authorized user of the motor vehicle based on data received from the key fob device before opening the tailgate.

7. A motor vehicle, the motor vehicle comprising:
a tailgate hinged to a upper side of a rear portion of the vehicle;
an actuator to open the tailgate;
a control system to regulate the actuator to open and close the tailgate;
a user detection system to detect a person approaching the vehicle;
the user detection system including an ultra-wide band signal device and a video camera, the user detection system being configured to detect a height of the approaching person using ultra-wide band signals from the ultra-wide band signal device in combination with video data captured by the video camera; and
the user detection system communicating with the control system to open the tailgate at a level that is above the height of the approaching person.

8. The motor vehicle of claim 7, wherein the user detection system is configured to engage in wireless electronic communication with a mobile computing device associated with the approaching person using the ultra-wide band signals from the ultra-wide band signal device, and determine that the approaching person is an authorized person based on data received from the mobile computing device via the ultra-wide band signals before opening the tailgate.

9. The motor vehicle of claim 7, wherein the user detection system is configured to engage in wireless electronic communication with a key fob device carried by the approaching person using the ultra-wide band signals from the ultra-wide band signal device, and determine that the approaching person is an authorized person based on data received from the key fob device via the ultra-wide band signals before opening the tailgate.

10. The motor vehicle of claim 7, wherein the user detection system further detects that the approaching person has subsequently moved away from the rear portion of the vehicle, and then communicates with the control system to close the tailgate.

11. The motor vehicle of claim 7, wherein the user detection system communicates with the control system to open the tailgate to a level that is above the height of the approaching person but less than fully open.

12. The motor vehicle of claim 7, wherein the user detection system determines an approach velocity of the approaching person, and communicates with the control system to open the tailgate at a time such that the tailgate is opened to the level that is above the height of the approaching person just as the approaching person arrives at the rear portion of the motor vehicle.

13. The motor vehicle of claim 7, wherein the user detection system determines a gait analysis of the approaching person using the ultra-wide band signals from the ultra-wide band signal device, and communicates with the control system to open the tailgate when the gait analysis corresponds to a preprogramed gait analysis of an authorized user that is digitally stored in the control system.

14. A method for automatically opening a tailgate of a motor vehicle comprising the steps of:
detecting a person approaching the motor vehicle;
detecting a height of the person approaching the vehicle using ultra-wide band signals;
determining if the person approaching the motor vehicle is an authorized user to operate the land vehicle using the ultra-wide band signals;
opening the tailgate to a level that is above the height of the approaching person but less than fully open.

15. The method for automatically opening a tailgate of a motor vehicle of claim 14, and further comprising the steps of:
determining an approach speed of the person approaching the land vehicle; and,
opening the tailgate just in time as the user approaches the rear portion of the vehicle.

16. The method for automatically opening a tailgate of a motor vehicle of claim 14, and further comprising the steps of:
using a camera to detect the person approaching the motor vehicle, in combination with the ultra-wide band signals;
determining an approach speed of the person approaching the land vehicle; and,
opening the tailgate just in time as the user approaches the rear portion of the vehicle.

17. The method for automatically opening a tailgate of a motor vehicle of claim 14, and further comprising the step of:
using a camera to detect the person approaching the motor vehicle, in combination with the ultra-wide band signals.

18. The method for automatically opening a tailgate of a motor vehicle of claim 14, wherein the step of determining if the person is an authorized user includes detecting a mobile computing device carried by the authorized user and receiving data from the mobile computing device via the ultra-wide ban signals indicating that the person is an authorized user.

19. The method for automatically opening a tailgate of a motor vehicle of claim 14, further comprising the steps of:
detecting when the person has moved away from the rear of the vehicle when the tailgate is open, and then
closing the tailgate.

20. The method for automatically opening a tailgate of a motor vehicle of claim 14, further comprising the steps of:
detecting when the person has moved away from the rear of the vehicle when the tailgate is open;
starting to close the tailgate;
detecting that the person has moved towards the rear of the vehicle while the tailgate is in the process of closing; and
pausing the closing of the tailgate, and reopening the tailgate.
